(19) United States
(12) Patent Application Publication
(10) Pub. No.: US 2026/0287427 A1
(43) Pub. Date: Sep. 24, 2026

(54) ELECTRIC FIELD ENHANCEMENT ELEMENT AND RAMAN SPECTROSCOPIC APPARATUS

(71) Applicant: SEIKO EPSON CORPORATION, Tokyo (JP)

(72) Inventor: Fumika YAMADA, SHIOJIRI-SHI (JP)

(73) Assignee: SEIKO EPSON CORPORATION, Tokyo (JP)

(21) Appl. No.: 19/574,461

(22) Filed: Mar. 23, 2026

(30) Foreign Application Priority Data
Mar. 24, 2025 (JP) 2025-048114

(51) Int. Cl. G01J 3/44

(52) U.S. Cl. CPC G01J 3/44

(57) ABSTRACT

An electric field enhancement element includes: a substrate; a plurality of microstructures provided at the substrate and having conductivity; a cover layer covering the plurality of microstructures and the substrate; and a transparent layer covering the cover layer. A thickness of the cover layer is smaller than a thickness of the transparent layer. 0 < Δn ≤ 1.000, wherein Δn is a refractive index difference between a refractive index of the cover layer and a refractive index of the transparent layer.

### CROSS-REFERENCE TO RELATED APPLICATION

The present application is based on, and claims priority from JP Application Serial Number 2025-048114, filed Mar. 24, 2025, the disclosure of which is hereby incorporated by reference herein in its entirety.

### BACKGROUND

### 1. Technical Field

The present disclosure relates to an electric field enhancement element and a Raman spectroscopic apparatus.

### 2. Related Art

A Raman spectroscopic apparatus using localized surface plasmon resonance (LSPR) is known as one of spectroscopic techniques for detecting low-concentration sample molecules. In such a Raman spectroscopic apparatus, an enhanced electric field is formed by an electric field enhancement element having a nanometer-scale microstructure to generate surface enhanced Raman scattering (SERS).

For example, JP-A-2013-096939 discloses an LSPR measurement chip including a substrate made of a light transmissive substance and an organic molecule immobilization portion provided at the substrate and having a nano-pattern of a non-light transmissive substance. Organic molecules such as antibodies and enzymes are immobilized on the organic molecule immobilization portion.

In such an LSPR measurement chip, when transmitted light is emitted in a state in which a substance capable of reacting with the organic molecules is supplied as a substance to be measured, LSPR is induced with respect to the transmitted light, and Raman scattering light is excited. Accordingly, it is possible to enhance a scattering light intensity more than usual Raman scattering.

JP-A-2024-143322 discloses an electric field enhancement element including a substrate, a plurality of microstructures provided at the substrate, and a transparent layer covering the microstructures and the substrate. In such an electric field enhancement element, since a target substance can be disposed at the transparent layer, it is possible to prevent deterioration, deformation, or the like of the microstructures. Since an enhanced electric field can be formed at a position away from the microstructures by guiding the emitted light in the transparent layer, a detection signal caused by the target substance disposed at the transparent layer can be enhanced.

JP-A-2013-096939 and JP-A-2024-143322 are examples of the related art.

In the electric field enhancement element described in JP-A-2024-143322, an interface with the microstructures and an interface with the substrate are present in the transparent layer. Therefore, the transparent layer may become heterogeneous depending on a formation state of the transparent layer. When the transparent layer becomes heterogeneous, the light guided through the transparent layer is easily attenuated.

### SUMMARY

An electric field enhancement element according to an application example of the present disclosure includes:

a substrate;

a plurality of microstructures provided at the substrate and having conductivity;

a cover layer covering the plurality of microstructures and the substrate; and

a transparent layer covering the cover layer, wherein

a thickness of the cover layer is smaller than a thickness of the transparent layer, and

0 < Δn ≤ 1.000, wherein Δn is a refractive index difference between a refractive index of the cover layer and a refractive index of the transparent layer.

A Raman spectroscopic apparatus according to an application example of the present disclosure includes:

the electric field enhancement element according to the application example of the present disclosure;

a light source configured to irradiate the electric field enhancement element with light; and

a detector configured to detect Raman scattering light generated from the electric field enhancement element.

### BRIEF DESCRIPTION OF THE DRAWINGS

FIG. 1 is a cross-sectional view schematically showing an electric field enhancement element according to an embodiment.

FIG. 2 is a plan view schematically showing microstructures of the electric field enhancement element according to the embodiment.

FIG. 3 is a partially enlarged view of FIG. 1.

FIG. 4 is a cross-sectional view schematically showing an electric field enhancement element according to a first modification of the embodiment.

FIG. 5 is a cross-sectional view schematically showing an electric field enhancement element according to a second modification of the embodiment.

FIG. 6 is a cross-sectional view showing an example of a method for manufacturing the electric field enhancement element shown in FIG. 5.

FIG. 7 is a cross-sectional view showing an example of the method for manufacturing the electric field enhancement element shown in FIG. 5.

FIG. 8 is a diagram schematically showing a Raman spectroscopic apparatus according to the embodiment.

FIG. 9 is a diagram showing a principle of Raman scattering spectroscopy.

FIG. 10 is a schematic diagram showing an example of a Raman spectrum acquired by the Raman scattering spectroscopy.

FIG. 11 is Table 1 showing configurations and evaluation results of electric field enhancement elements in Examples and Comparative Examples.

FIG. 12 shows an observation result of the electric field enhancement element in Example 1 and an electron beam diffraction pattern of a transparent layer.

FIG. 13 shows an observation result of the electric field enhancement element in Comparative Example 2 and an electron beam diffraction pattern of a transparent layer.

FIG. 14 is an XZ cross-sectional view schematically showing a model M used in a simulation experiment A.

FIG. 15 is a graph showing a result of the simulation experiment A.

FIG. 16 is a diagram showing the result of the simulation experiment A when a refractive index difference Δn is 0.200.

FIG. 17 is a diagram showing the result of the simulation experiment A when the refractive index difference Δn is 0.800.

### DESCRIPTION OF EMBODIMENTS

An electric field enhancement element and a Raman spectroscopic apparatus of the present disclosure will hereinafter be described in detail based on an embodiment shown in the accompanying drawings.

### 1. Electric Field Enhancement Element

First, the electric field enhancement element according to the embodiment will be described.

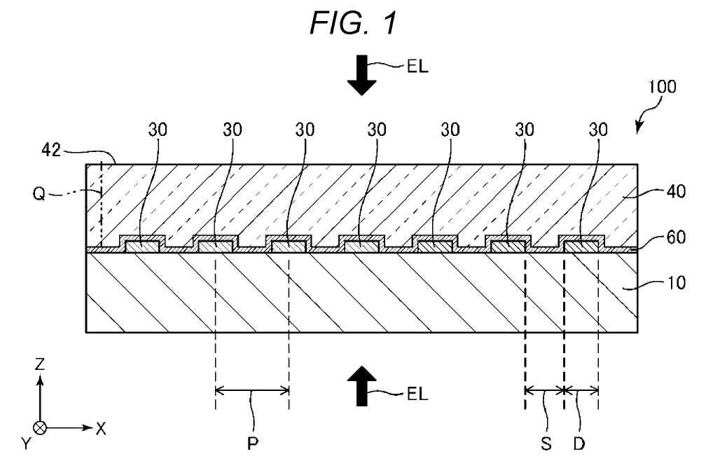

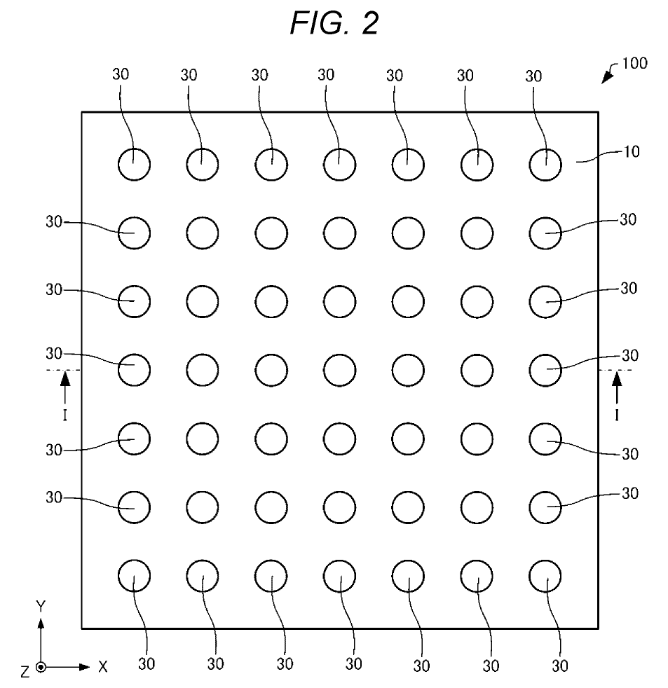

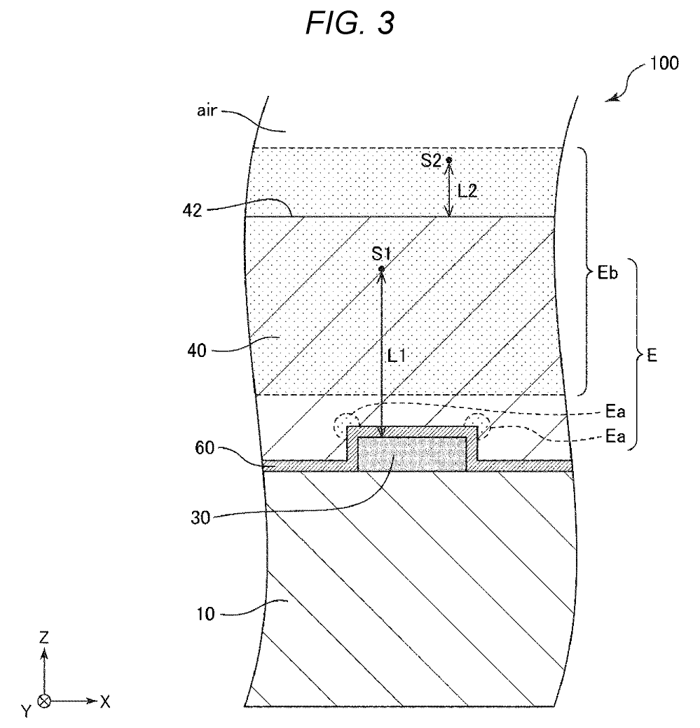

FIG. 1 is a cross-sectional view schematically showing an electric field enhancement element 100 according to the embodiment. FIG. 2 is a plan view schematically showing microstructures 30 of the electric field enhancement element 100 according to the embodiment. FIG. 1 is a cross-sectional view along a line I-I in FIG. 2. FIG. 3 is a partially enlarged view of FIG. 1.

In each of the drawings of the present application, an X axis, a Y axis, and a Z axis are set as three axes orthogonal to one another, and are respectively indicated by arrows. A tip side of the arrow of each axis is referred to as a "plus side", and a base end side thereof is referred to as a "minus side". A plus side of the Z axis is referred to as "upper", and a minus side of the Z axis is referred to as "lower".

### 1.1. Schematic Configuration

The electric field enhancement element 100 shown in FIGS. 1 and 2 includes a substrate 10, the microstructures 30, a cover layer 60, and a transparent layer 40. In FIG. 2, the transparent layer 40 and the cover layer 60 are not shown.

The substrate 10 supports a plurality of microstructures 30 having conductivity. When light EL from a light source used for Raman scattering is incident from the substrate 10 side in FIG. 1, the incident light EL is transmitted through the substrate 10 and reaches the microstructures 30. When the light EL is incident from the transparent layer 40 side in FIG. 1, the incident light EL is transmitted through the transparent layer 40 and reaches the microstructures 30. In this case, the light EL incident from the transparent layer 40 side may be reflected to the transparent layer 40 side by the substrate 10.

When the incident light EL reaches the plurality of microstructures 30, an enhanced electric field stronger than an electric field of the light EL is generated. The enhanced electric field is preferably maximized at a position above the microstructures 30, that is, at a position on an opposite side of the microstructures 30 to the substrate 10 in an extending direction of a perpendicular line Q to the substrate 10 and separated from the plurality of microstructures 30. Accordingly, a detection signal caused by a target substance disposed at the transparent layer 40 can be enhanced. As a result, the electric field enhancement element 100 in which an improvement in the detection sensitivity of the target substance is achieved can be obtained.

As shown in FIG. 1, the cover layer 60 covers the plurality of microstructures 30 and the substrate 10. As shown in FIG. 1, the transparent layer 40 covers the cover layer 60. In the present specification, the term "cover" includes not only a state of overlapping the entire covered surface but also a state of overlapping only partially.

The cover layer 60 is interposed between the microstructures 30 or the substrate 10 and the transparent layer 40, thereby contributing to improvement of homogeneity when the transparent layer 40 is formed. A thickness of the cover layer 60 is smaller than a thickness of the transparent layer 40. Accordingly, it is possible to improve the enhanced electric field in the transparent layer 40 and above the transparent layer 40.

In the electric field enhancement element 100, a difference (refractive index difference Δn) between a refractive index of the cover layer 60 and a refractive index of the transparent layer 40 satisfies 0 < Δn ≤ 1.000. By satisfying such a relationship, the refractive index difference Δn can be sufficiently limited. As a result, reflection of light due to the refractive index difference Δn can be limited at an interface between the cover layer 60 and the transparent layer 40, and thus the enhanced electric field is more easily formed.

### 1.2. Substrate

Examples of the substrate 10 include a glass substrate and a silicon substrate. Examples of the constituent material of the glass substrate include SiO₂ (quartz glass). Examples of the constituent material of the silicon substrate include single crystal silicon, polycrystalline silicon, and amorphous silicon.

When the light EL is introduced from the substrate 10 side of the electric field enhancement element 100 (when the electric field enhancement element 100 is a transmission type), a material through which the light EL transmits is used as a constituent material of the substrate 10. On the other hand, when the light EL is introduced from the transparent layer 40 side (when the electric field enhancement element 100 is on the reflection side), a material that reflects the light EL is used as the constituent material of the substrate 10.

In FIG. 1, the substrate 10 extends along an XY plane, and the perpendicular line Q to an upper surface of the substrate 10 is parallel to the Z axis.

### 1.3. Microstructure

The plurality of microstructures 30 shown in FIG. 1 are provided between the substrate 10 and the transparent layer 40. The plurality of microstructures 30 is separated from each other. The transparent layer 40 is provided between the microstructures 30 adjacent to each other. The plurality of microstructures 30 are periodically provided at a predetermined pitch in a predetermined direction when viewed from a Z axis direction. In the example shown in FIG. 2, the plurality of microstructures 30 are arranged in a square lattice shape, but the arrangement pattern is not limited thereto.

A pitch P of the microstructures 30 is not particularly limited, and is preferably 20 nm or more and 1000 nm or less, and more preferably 100 nm or more and 900 nm or less. As shown in FIG. 1, the "pitch P of the microstructures 30" is a distance between centers of the microstructures 30 adjacent to each other in the predetermined direction. When a planar shape of the microstructure 30 is a circle, the "center of the microstructure 30" is a center of the circle, and when the planar shape of the microstructure 30 is not a circle, the "center of the microstructure 30" is a center of a minimum inclusion circle.

According to such a configuration, in the electric field enhancement element 100, it is possible to reduce a variation in the intensity of the enhanced electric field in an in-plane direction of the substrate 10. When the plurality of microstructures 30 is randomly arranged, only the microstructures 30 having a diameter or a pitch matching the wavelength of the light EL from the light source induce the LSPR. Therefore, there is a possibility that the intensity of the enhanced electric field varies in the in-plane direction. In contrast, since the microstructures 30 are periodically provided, it is possible to induce surface lattice resonance (SLR) described later.

A three-dimensional shape of the microstructure 30 is, for example, a columnar body such as a cylinder. The three-dimensional shape of the microstructure 30 may be a truncated conical body such as a truncated cone, or may be a conical body such as a cone.

The planar shape (shape when viewed from the Z axis) of the microstructure 30 is not particularly limited, and may be a shape other than the above, for example, a trapezoid, a semicircle, a reverse tapered shape, and a tip spherical shape.

A diameter D of the microstructure 30 is not particularly limited, and is preferably 1 nm or more and 1000 nm or less, more preferably 5 nm or more and 500 nm or less, and still more preferably 10 nm or more and 400 nm or less.

When the planar shape (shape when viewed from the Z axis) of the microstructure 30 is a circle, the "diameter D of the microstructure 30" is a diameter of the circle, and when the planar shape of the microstructure 30 is not a circle, the "diameter D of the microstructure 30" is a diameter of the minimum inclusion circle. As an example of the latter, when the planar shape of the microstructure 30 is a polygon, a minimum circle including the polygon inside is the "minimum inclusion circle". Further, when the planar shape of the microstructure 30 is an ellipse, a minimum circle including the ellipse inside is the "minimum inclusion circle".

The diameter D of the microstructure 30 may be equal to or smaller than an interval S between the microstructures 30 adjacent to each other, and is preferably larger than the interval S. According to such a configuration, an arrangement density of the microstructures 30 can be sufficiently increased. Accordingly, variation in the distribution of the enhanced electric field on the XY plane can be limited. As a result, the detection signal caused by the target substance can be enhanced regardless of the arrangement of the target substance on the transparent layer 40.

As shown in FIG. 1, the interval S is a separation distance between the microstructures 30 in the predetermined direction.

In the present specification, a ratio of the diameter D to a sum (D + S) of the diameter D and the interval S is referred to as a "duty ratio of the microstructure 30". The duty ratio of the microstructure 30 is preferably 50% or more, more preferably 60% or more and 99% or less, and still more preferably 70% or more and 95% or less. By setting the duty ratio of the microstructure 30 within the above range, the variation in the distribution of the enhanced electric field on the XY plane can be particularly limited. When there are a plurality of duty ratios depending on the arrangement direction of the microstructures 30, the largest duty ratio may be focused.

A thickness of the microstructure 30 is not particularly limited, and is preferably 1 nm or more and 500 nm or less, more preferably 5 nm or more and 300 nm or less, and still more preferably 30 nm or more and 200 nm or less. Accordingly, the enhanced electric field can further be enhanced.

The thickness of the microstructure 30 is measured from an observation image obtained by magnifying and observing a cross section of the electric field enhancement element 100 with an electron microscope. The thicknesses of the microstructures 30 at 10 or more locations in the observation image are measured, and an average value thereof is referred to as the "thickness of the microstructure 30". The thicknesses of the other portions are also measured and calculated in the same manner.

The microstructures 30 have conductivity. Examples of the constituent material of the microstructures 30 include simple substances or alloys of metals such as Al, Au, Ag, Cu, Pt, Pd, and Ni. Since such a metal has particularly good conductivity, the enhanced electric field can be further enhanced. Further, the microstructures 30 may be metal particles.

The constituent material of the microstructure 30 is not limited to metal, and may be a transparent electrode material such as indium tin oxide (ITO), a carbon-based material such as carbon nanotubes, or the like.

### 1.4. Cover Layer

As shown in FIG. 1, the cover layer 60 covers the plurality of microstructures 30 and the substrate 10. Specifically, the cover layer 60 is provided at the upper surface and the side surface of the microstructures 30 and the upper surface of the substrate 10 located between the microstructures 30. The cover layer 60 is interposed between the microstructures 30 or the substrate 10 and the transparent layer 40, thereby contributing to improvement of homogeneity when the transparent layer 40 is formed. It is considered that such an effect is obtained because the variation in a film formation state of the transparent layer 40 is limited by making the constituent materials of the base of the transparent layer 40 uniform. By enhancing the homogeneity of the transparent layer 40, the enhanced electric field formed in the vicinity of the microstructure 30 can be propagated over a wide range of the transparent layer 40. Accordingly, it is possible to improve the enhanced electric field in the transparent layer 40 and above the transparent layer 40.

Since the constituent material of the base is uniform, even when a film formation speed of the transparent layer 40 is increased, it is less likely to be reflected in the variation in the film formation state. Therefore, the film formation efficiency of the transparent layer 40 can be increased.

The thickness of the cover layer 60 is smaller than the thickness of the transparent layer 40. Accordingly, the influence of the cover layer 60 on the propagation of the enhanced electric field is minimized. Accordingly, even when there is a refractive index difference between the cover layer 60 and the transparent layer 40, the enhanced electric field formed in the vicinity of the microstructure 30 can be propagated over the wide range of the transparent layer 40.

In the electric field enhancement element 100, the difference (refractive index difference Δn) between the refractive index of the cover layer 60 and the refractive index of the transparent layer 40 satisfies 0 < Δn ≤ 1.000. By satisfying such a relationship, the refractive index difference Δn can be sufficiently limited. As a result, reflection of light due to the refractive index difference Δn can be limited at the interface between the cover layer 60 and the transparent layer 40, and thus the enhanced electric field is more easily formed.

The refractive index difference Δn preferably satisfies 0 < Δn ≤ 0.800, and more preferably satisfies 0 < Δn ≤ 0.600. The "refractive index" in the present specification is a refractive index at a wavelength of 410 nm.

The refractive index of the cover layer 60 may be less than the refractive index of the transparent layer 40, and is preferably higher than the refractive index of the transparent layer 40. According to such a configuration, the propagation efficiency of light from the cover layer 60 toward the transparent layer 40 is increased. Therefore, the enhanced electric field formed in the vicinity of the microstructure 30 is easily propagated to the wide range of the transparent layer 40.

The thickness of the cover layer 60 is preferably 1 nm or more and less than 100 nm, more preferably 3 nm or more and 50 nm or less, and still more preferably 5 nm or more and 20 nm or less. When the thickness of the cover layer 60 is within the above range, the influence of the cover layer 60 on the light EL, specifically, unintended reflection, absorption, or the like for the light EL by the cover layer 60 can be minimized, and the variation in the film formation state when the transparent layer 40 is formed can be limited.

When the thickness of the cover layer 60 is less than the above lower limit value, the thickness of the cover layer 60 is insufficient, and thus the continuity of the cover layer 60 may decrease. In this case, the function of the cover layer 60 cannot be sufficiently exhibited, and the homogeneity of the transparent layer 40 may not be sufficiently enhanced. On the other hand, when the thickness of the cover layer 60 exceeds the above upper limit value, the thickness of the cover layer 60 becomes excessive, and thus it may take time to form the cover layer 60, or reflection, absorption, or the like may easily occur depending on the constituent material of the cover layer 60.

The constituent material of the cover layer 60 is a material transparent to the light EL from the light source. Examples of the constituent material of the cover layer 60 include various inorganic materials such as Al₂O₃, TiO₂, MgO, LiNbO₃, HfO₂, Ta₂O₅, SiON, Si₃N₄, and SiOx (0 < x < 3). Further, SiOx (0 < x < 3) is preferably SiOx (1 < x ≤ 2). These inorganic materials have properties similar to those of the constituent material of the transparent layer 40, and thus contribute to the uniformity of the film formation state of the transparent layer 40.

The constituent material of the cover layer 60 may be a composite material containing two or more of these materials. Further, the cover layer 60 may be formed of a plurality of layers having different constituent materials.

The constituent materials of the cover layer 60 and the transparent layer 40 may be the same as each other, but are preferably different from each other. Accordingly, a material having good film thinning and coverage can be selected as the constituent material of the cover layer 60, and a material having good transparency and film formation speed can be selected as the constituent material of the transparent layer 40. As a result, since the cover layer 60 having high coverage can be formed, the transparent layer 40 can be further homogenized. In addition, the film formation efficiency of the transparent layer 40 can be easily increased.

The form of the cover layer 60 may be a vapor deposition film or a coating film. In the present specification, the "vapor deposition film" refers to a film formed by a vapor phase film formation method, and the "coating film" refers to a film formed by a liquid phase film formation method. Among these, the cover layer 60 is preferably a vapor deposition film. Accordingly, the cover layer 60 having good coverage can be obtained even when the cover layer 60 is thin. As a result, the cover layer 60 having a large effect of improving the homogeneity of the transparent layer 40 and improving the propagation of the enhanced electric field is obtained.

Examples of the vapor deposition film include a vacuum vapor deposition film formed by a vacuum vapor deposition method, a sputtering film formed by a sputtering method, a thermal oxide film formed by a thermal oxidation method, a plasma polymerization film formed by a plasma polymerization method, a chemical vapor deposition (CVD) film formed by a CVD method, and an ALD film formed by an atomic layer deposition (ALD) method.

Among these, an ALD film is preferably used for the cover layer 60. By using the ALD film, it is possible to obtain the cover layer 60 having particularly good both film thinning and coverage.

### 1.5. Transparent Layer

The transparent layer 40 is provided at the microstructures 30 and the substrate 10. That is, the transparent layer 40 covers the plurality of microstructures 30 and the substrate 10. The thickness of the transparent layer 40 is not particularly limited, and is preferably 10 nm or more and 2000 nm or less, and more preferably 20 nm or more and 1000 nm or less.

The transparent layer 40 is transparent with respect to the light EL from the light source. Examples of the constituent material of the transparent layer 40 include various dielectrics such as Al₂O₃, TiO₂, MgO, LiNbO₃, HfO₂, Ta₂O₅, SiON, Si₃N₄, and SiOx (0 < x < 3). Further, SiOx (0 < x < 3) is preferably SiOx (1 < x ≤ 2). The constituent material of the transparent layer 40 may be an organic material such as acrylic resin (PMMA), polyvinyl alcohol (PVA), polysilazane, or polystyrene.

By providing such the transparent layer 40, the microstructure 30 can be protected from unintended chemical changes such as oxidation and sulfurization. Accordingly, the durability and reliability of the electric field enhancement element 100 can be improved.

The transparent layer 40 may be formed of a plurality of layers. In this case, the constituent materials of the plurality of layers may be the same as each other, or may be different from each other.

The transparent layer 40 has, for example, an upper surface 42 serving as an interface with an air layer. The upper surface 42 is a surface on which the target substance to be detected is disposed. The upper surface 42 may be a surface with unevenness or a flat surface. In the former case, there is an advantage that the target substance is easily captured. In the latter case, even when the target substance is large, the target substance can be stably held on the upper surface 42.

The constituent material of the transparent layer 40 may be crystalline, and is preferably amorphous. When the transparent layer 40 is amorphous, since a crystal grain boundary is not present or is present in a small amount, scattering of light due to the crystal grain boundary, occurrence of defects due to the crystal grain boundary, or the like can be limited. Accordingly, the propagation of the enhanced electric field in the transparent layer 40 can be further improved.

As a method for specifying that the transparent layer 40 is crystalline or amorphous, a method for acquiring an electron beam diffraction pattern and confirming the presence or absence of a diffraction spot due to crystal symmetry is exemplified.

### 1.6. Enhanced Electric Field

FIG. 3 shows an enhanced electric field E generated by the microstructures 30.

When the light EL incident from the substrate 10 side reaches the plurality of microstructures 30, the above-described LSPR is induced. The wavelength of the light is, for example, 350 nm or more and 850 nm or less. In addition, 90°-diffraction by the plurality of microstructures 30, that is, a Rayleigh anomaly occurs. When the Rayleigh anomaly and the LSPR are combined, a resonance state called plasmon polariton occurs. Examples of the plasmon polariton include surface lattice resonance (SLR) and quasi guided mode (QGM).

As shown in FIG. 3, the enhanced electric field E formed by the light EL includes a first enhanced field Ea generated at an end of the microstructure 30 due to the LSPR and a second enhanced field Eb generated above the microstructure 30 due to the resonance state such as SLR or QGM.

The enhanced electric field E is maximized at a position S1 or a position S2 separated upward from the plurality of microstructures 30 by the second enhanced field Eb. The positions S1 and S2 are positions on the opposite side of the plurality of microstructures 30 to the substrate 10 in the extending direction of the perpendicular line Q and are separated from the plurality of microstructures 30. Since the enhanced electric field E is maximized at the positions S1 and S2, even when the target substance is disposed at the upper surface 42, the enhanced electric field E acts on the target substance, and the detection signal (Raman scattering light) caused by the target substance can be enhanced. The enhanced Raman scattering light is referred to as surface enhanced Raman scattering (SERS) light. In the embodiment, the homogeneity of the transparent layer 40 is enhanced. Therefore, the propagation of the enhanced electric field E in the transparent layer 40 is improved, and the enhanced electric field E in the transparent layer 40 and above the transparent layer 40 can be improved. As a result, it is possible to implement the electric field enhancement element 100 capable of easily improving the detection sensitivity of the target substance disposed at the upper surface 42 of the transparent layer 40.

The second enhanced field Eb shown in FIG. 3 is separated from the first enhanced field Ea, but is not limited thereto, and may be continuous with the first enhanced field Ea.

The position S1 shown in FIG. 3 is in the transparent layer 40, and in this case, a distance L1 from the microstructure 30 to the position S1 in the extending direction of the perpendicular line Q to the upper surface 42 is preferably 100 nm or more, and more preferably 200 nm or more. Accordingly, since the enhanced electric field E generated above the upper surface 42 can be enhanced, the detection sensitivity of the target substance can be further improved.

Further, FIG. 3 shows a state in which the enhanced electric field E reaches the air layer "air" across the upper surface 42. The position S2 shown in FIG. 3 is in the air layer "air", and in this case, the detection sensitivity of the target substance disposed at the upper surface 42 can be further improved. In this case, a distance L2 from the upper surface 42 to the position S2 may be 100 nm or less or may exceed 100 nm. In the former case, when a size of the target substance is 100 nm or less, the probability that the position S2 acts on the target substance disposed at the upper surface 42 increases. In the latter case, even when the size of the target substance exceeds 100 nm, the probability that the position S2 acts on the target substance disposed at the upper surface 42 increases.

### 2. Method for Manufacturing Electric Field Enhancement Element

Next, an example of a method for manufacturing the electric field enhancement element 100 will be described.

First, the plurality of microstructures 30 are formed at the substrate 10. The microstructures 30 are formed by forming a thin film by a vapor phase film formation method such as a vacuum vapor deposition method or a sputtering method, and then patterning the thin film. Examples of the patterning method include electron beam (EB) lithography, photolithography and etching, a microcontact printing method, and a nanoimprint method.

Next, the cover layer 60 is formed at the substrate 10 and the microstructures 30. As described above, the cover layer 60 is formed by a vapor phase film formation method, a liquid phase film formation method, or the like. Among them, the vapor phase film formation method is preferably used, and the ALD method is more preferably used. In the ALD method, since a raw material can be deposited at an atomic layer level, a dense vapor deposition film can be formed even if it is thin. Further, in the ALD method, since the film formation property on the recessed portion or the shaded portion is good, the cover layer 60 having a high coverage can be formed.

Next, the transparent layer 40 is formed at the cover layer 60. The transparent layer 40 is formed by a vapor phase film formation method such as a vacuum vapor deposition method, a sputtering method, a CVD method, or an ALD method, or a liquid phase film formation method such as a sol-gel method. Among them, the vapor phase film formation method is preferably used, and the vacuum vapor deposition method is more preferably used.

### 3. Modifications of Electric Field Enhancement Element

Next, an electric field enhancement element according to a modification of the embodiment will be described.

### 3.1. First Modification

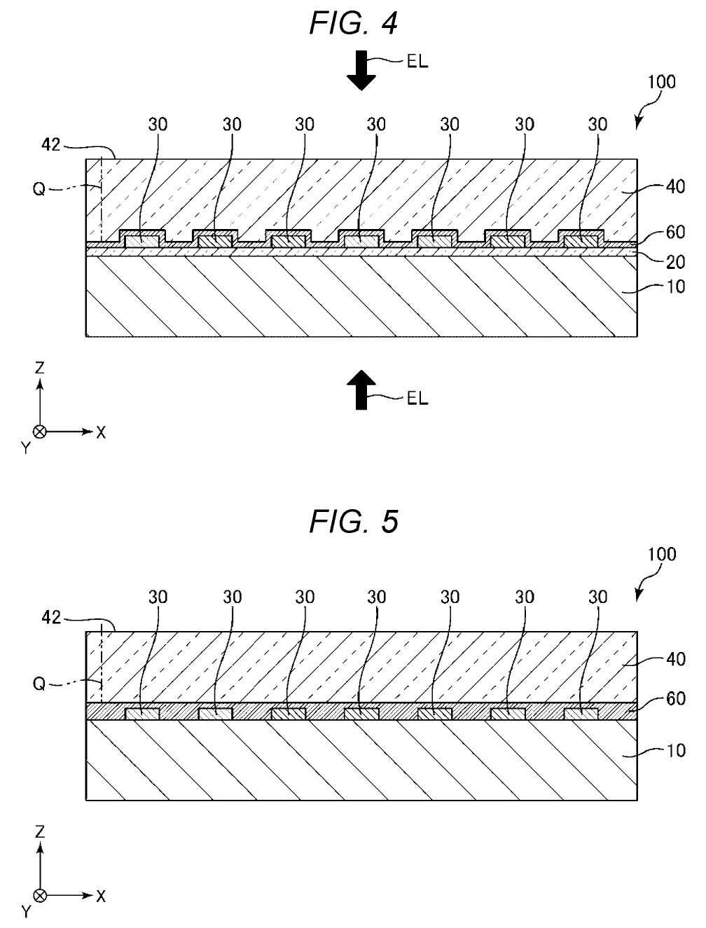

FIG. 4 is a cross-sectional view schematically showing the electric field enhancement element 100 according to a first modification of the embodiment.

The first modification of the embodiment will hereinafter be described, but in the following description, differences from the embodiment described above will mainly be described, and description of similar configurations will be omitted. In FIG. 4, substantially the same configurations as those in the embodiment described above are provided with the same reference symbols.

The electric field enhancement element 100 shown in FIG. 4 is the same as the electric field enhancement element 100 shown in FIG. 1 except that a dielectric layer 20 is further provided.

The dielectric layer 20 shown in FIG. 4 is provided between the substrate 10 and the microstructures 30 and between the substrate 10 and the cover layer 60. By providing such the dielectric layer 20, the dielectric layer 20 can be disposed below the microstructures 30, so that the refractive index around the microstructures 30 can be easily controlled. Accordingly, in a transmission diffraction (diffraction of the light EL incident from the substrate 10 side and transmitted through the electric field enhancement element 100) and a reflection diffraction (diffraction of the light EL incident from the transparent layer 40 side and reflected inside the electric field enhancement element 100) by the microstructures 30, the Rayleigh anomaly occurs under the same conditions. Accordingly, the plasmon polariton is further enhanced, and the enhanced electric field E formed at the transparent layer 40 or above the transparent layer 40 can be further enhanced. By providing the dielectric layer 20, a film quality of the microstructure 30 or the cover layer 60 is easily improved. That is, as compared with the case of forming a film at the substrate 10, in the case of forming a film at the dielectric layer 20, the microstructure 30 and the cover layer 60 having few defects or the like can be formed. Accordingly, the homogeneity of the transparent layer 40 formed at the cover layer 60 can be further enhanced.

The thickness of the dielectric layer 20 is not particularly limited, and is preferably 1 nm or more and 2000 nm or less, and more preferably 10 nm or more and 1000 nm or less.

The dielectric layer 20 is transparent with respect to the light EL from the light source. Examples of the constituent material of the dielectric layer 20 include Al₂O₃, TiO₂, MgO, LiNbO₃, HfO₂, Ta₂O₅, SiON, Si₃N₄, SiOx (0 < x < 3), acrylic resin (PMMA), polyvinyl alcohol (PVA), and polysilazane. The dielectric layer 20 may be formed of a plurality of layers. In this case, the constituent materials of the plurality of layers may be the same as each other, or may be different from each other.

The refractive index of the dielectric layer 20 may be different from, or may be the same as, the refractive index of the cover layer 60. When the refractive index of the dielectric layer 20 is the same as the refractive index of the cover layer 60, the Rayleigh anomaly is likely to occur. The refractive index difference between the two is preferably 0.20 or less. When the refractive index difference is within this range, the influence of the refractive index difference is limited, and the Rayleigh anomaly is likely to occur regardless of an incident direction of the light. Accordingly, the SLR is easily induced.

Examples of the method for forming the dielectric layer 20 include a vapor phase film formation method such as a vacuum vapor deposition method, a sputtering method, a CVD method, and an ALD method.

In the first modification as described above, the effects same as those of the above-described embodiment can be obtained.

### 3.2. Second Modification

FIG. 5 is a cross-sectional view schematically showing the electric field enhancement element 100 according to a second modification of the embodiment.

The second modification of the embodiment will hereinafter be described, but in the following description, differences from the embodiment described above will mainly be described, and description of similar configurations will be omitted. In FIG. 5, substantially the same configurations as those in the embodiment described above are provided with the same reference symbols.

The electric field enhancement element 100 shown in FIG. 5 is the same as the electric field enhancement element 100 shown in FIG. 1 except that the configuration of the cover layer 60 is different.

The cover layer 60 shown in FIG. 5 not only covers the plurality of microstructures 30 and the substrate 10, but also fills gaps between the microstructures 30. Therefore, in the portion where the cover layer 60 is provided at the substrate 10, the thickness of the cover layer 60 is larger than the thickness of the microstructure 30. The upper surface (surface in contact with the transparent layer 40) of the cover layer 60 shown in FIG. 5 is a flat surface.

According to such a configuration, the film formation state of the transparent layer 40 formed at the cover layer 60 can be made more uniform. That is, since the upper surface of the cover layer 60 is a flat surface, the variation in the film formation state of the transparent layer 40 is limited as compared with a case where the upper surface has unevenness. Accordingly, the homogeneity of the transparent layer 40 can be further enhanced. The shape of the upper surface of the cover layer 60 can be prevented from being reflected on the upper surface 42 of the transparent layer 40. Accordingly, the upper surface 42 of the transparent layer 40 is also a flat surface, and the light confinement property of the transparent layer 40 is improved. As a result, the enhanced electric field E formed at or above the transparent layer 40 can be further enhanced.

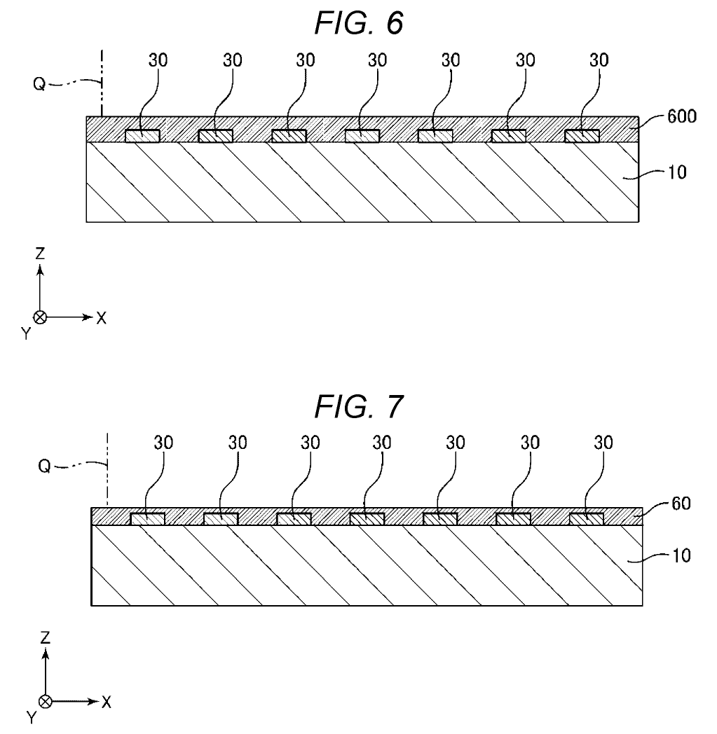

Next, an example of a method for manufacturing the electric field enhancement element 100 shown in FIG. 5 will be described. FIGS. 6 and 7 are cross-sectional views showing the example of the method for manufacturing the electric field enhancement element 100 shown in FIG. 5.

In the method for manufacturing the electric field enhancement element 100 shown in FIG. 5, first, the plurality of microstructures 30 are formed at the substrate 10.

Next, a cover layer 600 is formed to be thicker than the microstructure 30. In this case, the cover layer 600 is formed to fill the gap between the microstructures 30, and is also formed at the upper surface of the microstructures 30. As a result, as shown in FIG. 6, the cover layer 600 sufficiently thicker than the microstructure 30 is formed. The upper surface of the cover layer 600 may be a flat surface as shown in FIG. 6, or may be a surface with unevenness.

Next, a planarization treatment is performed on the upper surface of the cover layer 600. Examples of the planarization treatment include methods such as chemical mechanical polishing (CMP) and ion milling. By performing the planarization treatment on the cover layer 600, the cover layer 600 can be thinned to a necessary thickness. When the upper surface of the cover layer 600 has unevenness, planarization can be achieved. Accordingly, the cover layer 60 shown in FIG. 7 is obtained.

In this case, the thickness of the cover layer 60 provided at the microstructures 30 is preferably 1 nm or more and less than 100 nm, more preferably 3 nm or more and 50 nm or less, and still more preferably 5 nm or more and 20 nm or less.

Next, the transparent layer 40 is formed at the cover layer 60. Accordingly, the electric field enhancement element 100 shown in FIG. 5 is obtained.

In the second modification as described above, the effects same as those of the above-described embodiment can be obtained.

### 4. Raman Spectroscopic Apparatus

Next, a Raman spectroscopic apparatus according to the embodiment will be described.

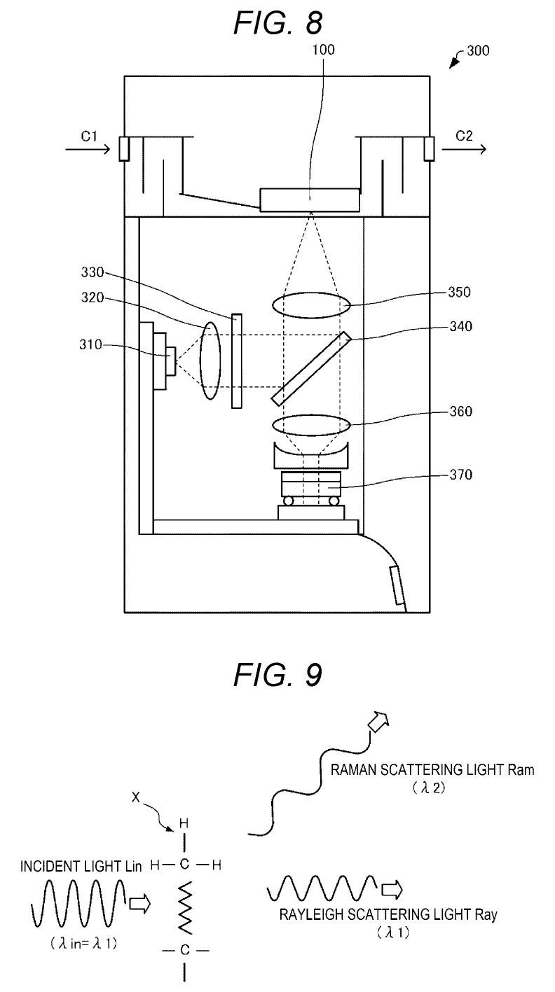

FIG. 8 is a diagram schematically showing a Raman spectroscopic apparatus 300 according to the embodiment.

### 4.1. Configuration

The Raman spectroscopic apparatus 300 shown in FIG. 8 includes the electric field enhancement element 100, a light source 310, a collimating lens 320, a polarization control element 330, a dichroic mirror 340, an objective lens 350, a condenser lens 360, and a detector 370. For the sake of convenience of illustration, the electric field enhancement element 100 is simplified in FIG. 8.

The target substance is introduced into the Raman spectroscopic apparatus 300 from an introduction direction C1 and carried out in a carry-out direction C2. Specifically, for example, by driving a fan (not shown), the target substance is introduced from a carry-in port into a substance transport unit and is carried out from a discharge port to the outside of the substance transport unit. The introduced target substance is disposed at the upper surface 42 of the transparent layer 40 of the electric field enhancement element 100.

The light source 310 irradiates the electric field enhancement element 100 with the light. The light emitted from the light source 310 has a wavelength that induces a resonance state such as plasmon polariton in the electric field enhancement element 100. Examples of the light source 310 include a laser and a light emitting diode (LED). Examples of the laser include a vertical cavity surface emitting laser (VCSEL) and a photonic crystal surface emitting laser (PCSEL).

The light emitted from the light source 310 is, for example, converted into parallel light by the collimating lens 320, transmitted through the polarization control element 330, and guided toward the electric field enhancement element 100 by the dichroic mirror 340. The light traveling toward the electric field enhancement element 100 is condensed by the objective lens 350 and is incident on the electric field enhancement element 100.

When the light is incident on the electric field enhancement element 100, the enhanced electric field E is generated by the plurality of microstructures 30. When the target substance is disposed in a space where the enhanced electric field E is generated, surface enhanced Raman scattering (SERS) light is generated. The SERS light is transmitted through the objective lens 350, transmitted through the dichroic mirror 340, condensed by the condenser lens 360, and incident on the detector 370.

The detector 370 detects the SERS light emitted from the electric field enhancement element 100. The detector 370 is, for example, a diffraction grating spectrometer. The detector 370 spectrally decomposes the SERS light and acquires spectral information. The detector 370 may be a Fabry-Perot etalon spectrometer.

### 4.2. Principle

FIG. 9 is a diagram showing a principle of Raman scattering spectroscopy. In FIG. 9, a target substance X is irradiated with incident light Lin having a wavelength λin. Then, scattering light is emitted from the target substance X. The scattering light includes, besides Rayleigh scattering light Ray having the same wavelength λ1 as the wavelength λin of the incident light Lin, Raman scattering light Ram having a wavelength λ2 different from the wavelength λ1. An energy difference between the Raman scattering light Ram and the incident light Lin corresponds to the energy of a vibration level, a rotation level, and an electron level of the target substance X. Since the target substance X has specific vibration energy according to the structure of the target substance X, the target substance X can be identified from the Raman scattering light Ram by using the incident light Lin having the wavelength λin.

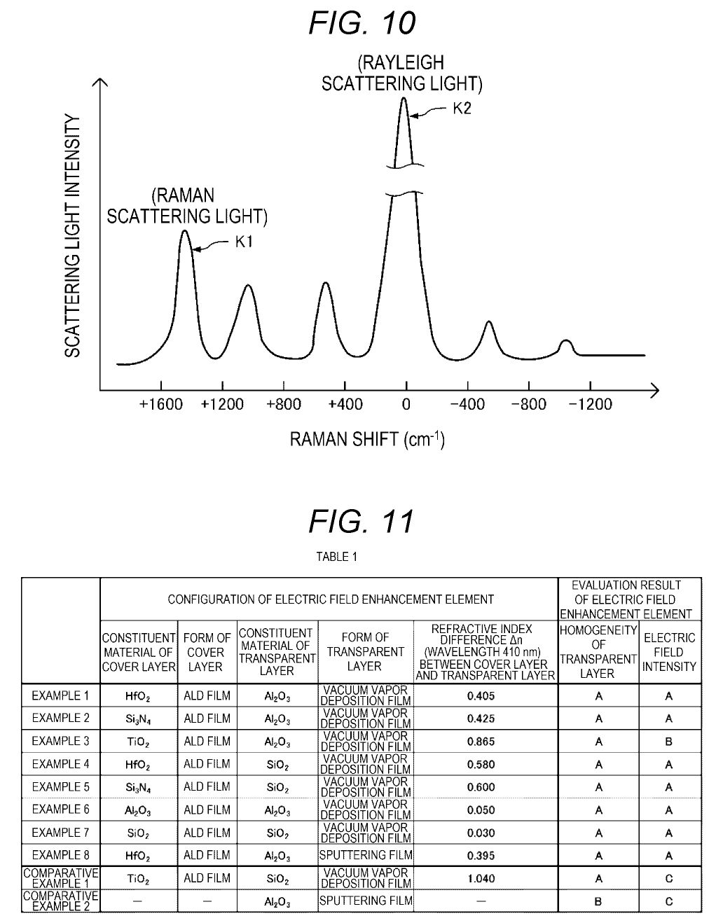

FIG. 10 is a schematic diagram showing an example of a Raman spectrum acquired by the Raman scattering spectroscopy. In FIG. 10, the horizontal axis represents a Raman shift. The Raman shift is a difference between a wave number (frequency) of the Raman scattering light Ram and a wave number of the incident light Lin, and has a value specific to the molecular bonding state of the target substance X.

When comparing a scattering light intensity K1 of the Raman scattering light Ram and a scattering light intensity K2 of the Rayleigh scattering light Ray shown in FIG. 10 with each other, it is understood that the scattering light intensity K1 of the Raman scattering light Ram is weaker. As described above, the Raman scattering spectroscopy is excellent in ability to identify the target substance X, but has a problem that the sensitivity to detect the target substance X is low. Therefore, in the Raman spectroscopic apparatus 300, the SERS is used to achieve high sensitivity.

### 5. Advantages Provided by Embodiment

The electric field enhancement element 100 according to the embodiment includes the substrate 10, the plurality of microstructures 30, the cover layer 60, and the transparent layer 40. The microstructures 30 are disposed at the substrate 10 and have conductivity. The cover layer 60 covers the plurality of microstructures 30 and the substrate 10. The transparent layer 40 covers the cover layer 60. The thickness of the cover layer 60 is smaller than the thickness of the transparent layer 40. Further, 0 < Δn ≤ 1.000, wherein Δn is the refractive index difference between the refractive index of the cover layer 60 and the refractive index of the transparent layer 40.

According to such a configuration, the transparent layer 40 can be homogenized, and the electric field enhancement element 100 capable of forming the enhanced electric field E in a wider range can be obtained.

In the electric field enhancement element 100 according to the embodiment, the constituent materials of the cover layer 60 and the transparent layer 40 may be different from each other.

According to such a configuration, a material having good film thinning and coverage can be selected as the constituent material of the cover layer 60, and a material having good transparency and film formation speed can be selected as the constituent material of the transparent layer 40. As a result, since the cover layer 60 having high coverage can be formed, the transparent layer 40 can be further homogenized. In addition, the film formation efficiency of the transparent layer 40 can be easily increased.

In the electric field enhancement element 100 according to the embodiment, the thickness of the cover layer 60 is preferably 1 nm or more and less than 100 nm.

According to such a configuration, the influence of the cover layer 60 on the light EL, specifically, unintended reflection, absorption, or the like for the light EL by the cover layer 60 can be minimized, and the variation in the film formation state when the transparent layer 40 is formed can be limited.

In the electric field enhancement element 100 according to the embodiment, the refractive index of the cover layer 60 may be higher than the refractive index of the transparent layer 40.

According to such a configuration, the propagation efficiency of the light EL from the cover layer 60 toward the transparent layer 40 is increased. Therefore, the enhanced electric field E formed in the vicinity of the microstructure 30 is easily propagated to the wide range of the transparent layer 40.

In the electric field enhancement element 100 according to the embodiment, the thickness of the cover layer 60 at the substrate 10 may be larger than the thickness of the microstructure 30.

According to such a configuration, since the upper surface of the cover layer 60 can be planarized, the film formation state of the transparent layer 40 formed thereon can be made more uniform. Accordingly, the homogeneity of the transparent layer 40 can be further enhanced. The shape of the upper surface of the cover layer 60 can be prevented from being reflected on the upper surface 42 of the transparent layer 40.

In the electric field enhancement element 100 according to the embodiment, the surface of the cover layer 60 in contact with the transparent layer 40 may be a flat surface.

According to such a configuration, the film formation state of the transparent layer 40 formed at the cover layer 60 can be made more uniform. That is, since the upper surface of the cover layer 60 is a flat surface, the variation in the film formation state of the transparent layer 40 is limited as compared with a case where the upper surface has unevenness. Accordingly, the homogeneity of the transparent layer 40 can be further enhanced.

In the electric field enhancement element 100 according to the embodiment, the diameter D of the microstructure 30 is preferably larger than the interval S between the microstructures 30 adjacent to each other.

According to such a configuration, an arrangement density of the microstructures 30 can be sufficiently increased. Accordingly, variation in the distribution of the enhanced electric field E on the XY plane can be limited. As a result, the detection signal caused by the target substance can be enhanced regardless of the arrangement of the target substance on the transparent layer 40.

In the electric field enhancement element 100 according to the embodiment, the microstructures 30 may be periodically arranged.

According to such a configuration, it is possible to reduce the variation in the intensity of the enhanced electric field E in the in-plane direction. In addition, since the microstructures 30 are periodically arranged, the SLR is easily induced.

In the electric field enhancement element 100 according to the embodiment, it is preferable that the enhanced electric field E generated by the microstructures 30 is maximized at a position on the opposite side of the microstructures 30 to the substrate 10 in the extending direction of the perpendicular line Q to the substrate 10 and separated from the plurality of microstructures 30.

According to such a configuration, even when the target substance is disposed at the upper surface 42, the enhanced electric field E acts on the target substance, and the detection signal caused by the target substance can be enhanced.

In the electric field enhancement element 100 according to the embodiment, the cover layer 60 is preferably an ALD film.

According to such a configuration, it is possible to obtain the cover layer 60 having particularly good both film thinning and coverage.

The Raman spectroscopic apparatus according to the embodiment described above includes the electric field enhancement element 100 according to the embodiment described above, the light source 310, and the detector 370. The light source 310 irradiates the electric field enhancement element 100 with the light EL. The detector 370 detects the Raman scattering light generated by the electric field enhancement element 100.

According to such a configuration, the Raman spectroscopic apparatus 300 capable of improving the detection sensitivity can be obtained.

Although the electric field enhancement element and the Raman spectroscopic apparatus according to the present disclosure have been described based on the preferred embodiment shown in the drawings, the present disclosure is not limited to the embodiment and the modifications. For example, the configuration of each unit in the embodiment and the modifications described above may be replaced with any configuration having substantially the same function, or may be added with any other configuration. Examples of the other configuration include a molecule trapping layer provided at the upper surface of the transparent layer. The molecule trapping layer is an organic molecular film, and specifically, is self-assembled monolayers (SAM) or the like. The present disclosure may be obtained by combining two or more of the embodiment and the modifications described above.

### EXAMPLES

Next, specific examples of the present disclosure will be described.

### 6. Production of Electric Field Enhancement Element

The electric field enhancement element of each example and each comparative example was produced as follows. FIG. 11 is Table 1 showing configurations and evaluation results of electric field enhancement elements in Examples and Comparative Examples.

### 6.1. Example 1

As the electric field enhancement element in Example 1, the electric field enhancement element shown in FIG. 1 was produced. The forms of the cover layer and the transparent layer and the refractive index difference between the cover layer 60 and the transparent layer 40 are as shown in Table 1 (FIG. 11).

The constituent materials of each part of the produced electric field enhancement element are as follows.

Substrate 10: Si

Microstructure 30: Al

Cover layer 60: HfO₂

Transparent layer 40: Al₂O₃

Further, the shape and size of each part of the electric field enhancement element are as follows.

Shape of microstructure 30: cylinder

Diameter of microstructure 30: 313 nm

Thickness of microstructure 30: 140 nm

Pitch of microstructure 30: 391 nm

Thickness of transparent layer 40: 470 nm to 590 nm

Thickness of cover layer 60: 10 nm

### 6.2. Examples 2 to 8

The electric field enhancement element in Examples 2 to 8 was produced in the same manner as in Example 1 except that the constituent materials of the cover layer 60 and the transparent layer 40 and the refractive index difference between the cover layer 60 and the transparent layer 40 were changed as shown in Table 1.

### 6.3. Comparative Example 1

The electric field enhancement element of Comparative Example 1 was produced in the same manner as in Example 1 except that the constituent materials of the cover layer 60 and the transparent layer 40 and the refractive index difference between the cover layer 60 and the transparent layer 40 were changed as shown in Table 1.

### 6.4. Comparative Example 2

The electric field enhancement element of Comparative Example 2 was produced in the same manner as in Example 1 except that the cover layer 60 was omitted and the configuration of the transparent layer was changed as shown in Table 1.

### 7. Evaluation of Electric Field Enhancement Element Evaluation of Homogeneity of Transparent Layer

The electric field enhancement element of each example and each comparative example was cut in a thickness direction of the substrate 10, and the cut surface was polished.

Next, the polished surface was observed with a scanning transmission electron microscope (STEM).

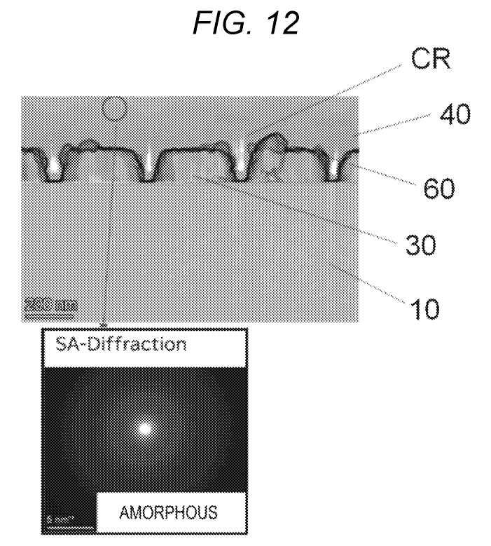

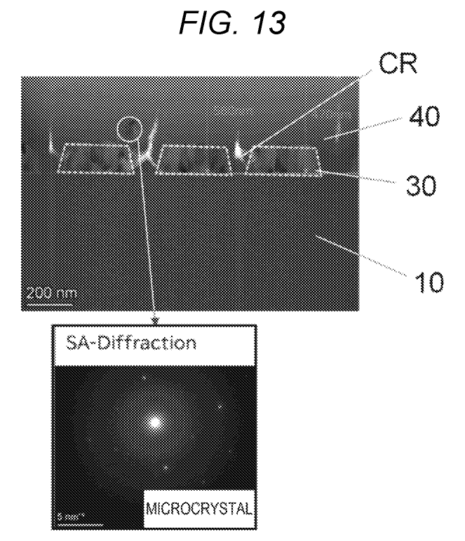

FIG. 12 shows an observation result of the electric field enhancement element in Example 1 and an electron beam diffraction pattern (SA-Diffraction) of the transparent layer. FIG. 13 shows an observation result of the electric field enhancement element in Comparative Example 2 and an electron beam diffraction pattern of the transparent layer.

In each of the observation results shown in FIGS. 12 and 13, a minute void CR is observed inside the transparent layer 40. In FIGS. 12 and 13, the void CR is a vertically elongated region represented by a color lighter than the surroundings. Among these, a distribution range of the void CR shown in FIG. 12 remains in the vicinity of the microstructure 30. On the other hand, the distribution range of the void CR shown in FIG. 13 extends long upward from the vicinity of the microstructure 30. Therefore, in the electric field enhancement element shown in FIG. 12, it was recognized that the distribution of the void CR was narrow and the homogeneity of the transparent layer 40 was high as compared with the electric field enhancement element shown in FIG. 13.

In the same manner as described above, the homogeneity of the transparent layer 40 was relatively evaluated by illuminating the observation result of each electric field enhancement element with the following evaluation criteria. Evaluation results are shown in Table 1.
A: The homogeneity of the transparent layer 40 is particularly high (the distribution of the void CR is particularly narrow)
B: The homogeneity of the transparent layer 40 is within an allowable range (the distribution of the void CR is wider than A but within the allowable range)
C: The homogeneity of the transparent layer 40 is low (the distribution of the void CR is wide and outside the allowable range)

In the electron beam diffraction pattern shown in FIG. 13, diffraction spots due to crystal symmetry were observed. Therefore, it is considered that the transparent layer 40 shown in FIG. 13 is formed of microcrystals. In contrast, in the electron beam diffraction pattern shown in FIG. 12, no diffraction spot was observed. Therefore, it is considered that the transparent layer 40 shown in FIG. 12 is formed of an amorphous material.

### 8. Simulation Experiment A

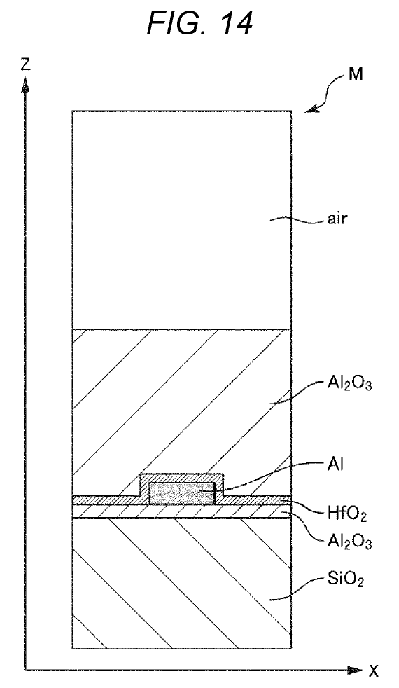

FIG. 14 is an XZ cross-sectional view schematically showing a model M used in a simulation experiment A.

In the simulation experiment A, first, the model M shown in FIG. 14 was input to simulation software. Rsoft manufactured by Synopsys was used as simulation software, and a finite difference time domain (FDTD) method was used as a method of calculating an enhanced electric field in a simulation.

The model M shown in FIG. 14 represents a structural unit obtained by cutting out the vicinity of one microstructure 30 among the electric field enhancement element including the plurality of microstructures 30. The model M includes the substrate 10, the dielectric layer 20, the microstructure 30, the transparent layer 40, and the cover layer 60.

In the model M, as shown in FIG. 14, the constituent material of the substrate 10 was quartz glass (SiO₂), the constituent material of the microstructure 30 was Al, the constituent material of the cover layer 60 was HfO₂, and the constituent materials of the dielectric layer 20 and the transparent layer 40 were Al₂O₃.

In the model M, an array of the microstructures 30 was a square lattice shape, the shape of the microstructure 30 was a cylinder, the diameter of the microstructure 30 was 156 nm, the height of the microstructure 30 was 60 nm, and the pitch P of the microstructure 30 was 391 nm. Further, the air layer "air" was formed above the transparent layer 40.

A simulation was performed in which light was incident from the substrate 10 side of the model M and a maximum value (electric field intensity) of the enhanced electric field in the transparent layer was estimated. The wavelength of the incident light was 410 nm. The simulation was repeated while changing the refractive index difference between the transparent layer 40 and the cover layer 60.

### 9. Result of Simulation Experiment A Evaluation Result of Relationship Between Refractive Index Difference Δn and Electric Field Intensity

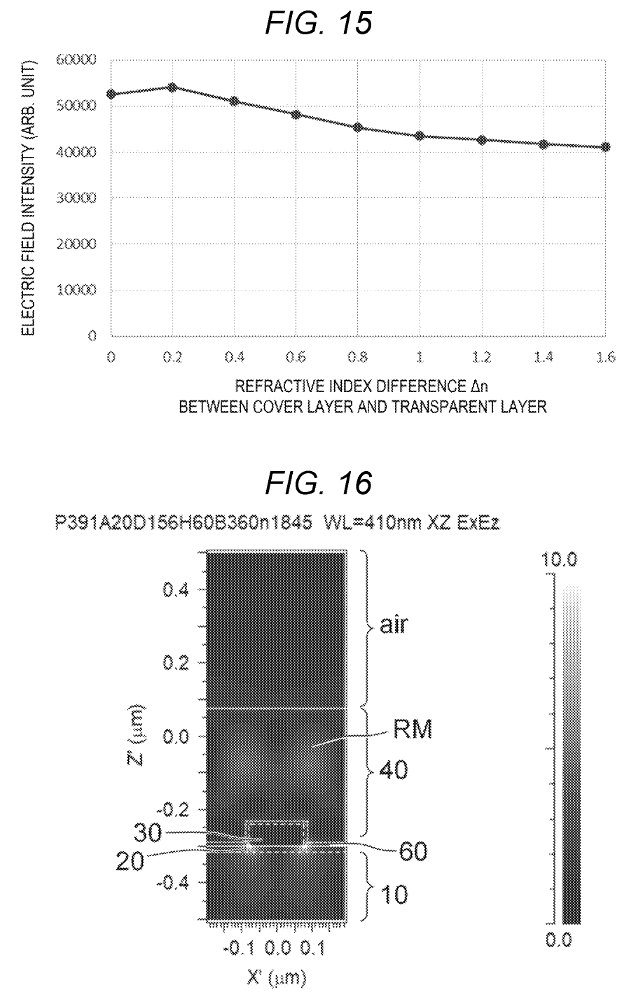

FIG. 15 is a graph showing a result of the simulation experiment A. The horizontal axis in FIG. 15 is the refractive index difference Δn between the cover layer 60 and the transparent layer 40, and the vertical axis in FIG. 15 is the electric field intensity in the transparent layer 40.

As shown in FIG. 15, as the refractive index difference Δn increased, the electric field intensity tended to gradually decrease. However, it was found that a sufficient electric field intensity was secured when a decrease rate was within a range of 0%~20%. Therefore, from the result shown in FIG. 15, it was found that the refractive index difference Δn between the transparent layer 40 and the cover layer 60 may be 1.000 or less in order to secure the sufficient electric field intensity in the transparent layer 40.

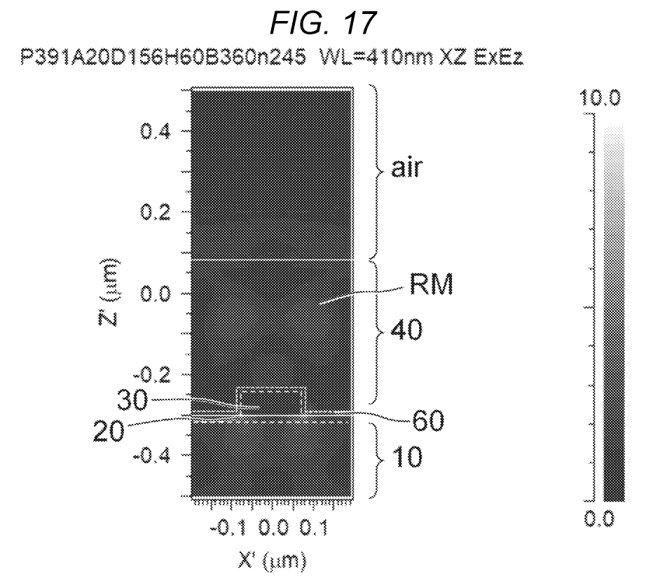

FIG. 16 is a diagram showing the result of the simulation experiment A when the refractive index difference Δn is 0.200. FIG. 17 is a diagram showing the result of the simulation experiment A when the refractive index difference Δn is 0.800.

As shown in FIGS. 16 and 17, when the refractive index difference Δn is 1.000 or less, a maximum point RM of the enhanced electric field is formed at a position separated from the microstructure 30. In such a case, the enhanced electric field can be enhanced in the transparent layer 40 and above the transparent layer 40.

### 10. Simulation Experiment B

In a simulation experiment B, a simulation for estimating the electric field intensity in the transparent layer 40 was performed for the electric field enhancement element in each example and each comparative example shown in Table 1. The wavelength of the incident light was 410 nm. The model M shown in FIG. 14 was used as a model of the electric field enhancement element.

### 11. Result of Simulation Experiment B Evaluation Result of Relationship Between Configuration of Element and Electric Field Intensity

The electric field intensity estimated in a simulation experiment B was relatively evaluated in light of the following evaluation criteria. Evaluation results are shown in Table 1.
A: The electric field intensity is sufficiently high
B: The electric field intensity is smaller than A but within an allowable range
C: The electric field intensity is insufficient

### 12. Consideration

From the above evaluation results, the following was recognized.

By providing the cover layer 60, the homogeneity of the transparent layer 40 of the electric field enhancement element is enhanced compared to a case where the cover layer 60 is not provided.

By providing the cover layer 60, the electric field intensity in the transparent layer 40 of the electric field enhancement element is enhanced compared to a case where the cover layer 60 is not provided.

It is considered that by enhancing the homogeneity of the transparent layer 40, the enhanced electric field propagates over the wide range of the transparent layer 40, and the electric field intensity is improved.

What is claimed is:

1. An electric field enhancement element comprising:
a substrate;
a plurality of microstructures provided at the substrate and having conductivity;
a cover layer covering the plurality of microstructures and the substrate; and
a transparent layer covering the cover layer, wherein
a thickness of the cover layer is smaller than a thickness of the transparent layer, and
00 < Δn ≤ 1.000, wherein Δn is a refractive index difference between a refractive index of the cover layer and a refractive index of the transparent layer.

2. The electric field enhancement element according to claim 1, wherein
constituent materials of the cover layer and the transparent layer are different from each other.

3. The electric field enhancement element according to claim 1, wherein
the thickness of the cover layer is 1 nm or more and less than 100 nm.

4. The electric field enhancement element according to claim 1, wherein
the refractive index of the cover layer is higher than the refractive index of the transparent layer.

5. The electric field enhancement element according to claim 1, wherein
the thickness of the cover layer at the substrate is larger than a thickness of each of the microstructures.

6. The electric field enhancement element according to claim 1, wherein
a surface of the cover layer in contact with the transparent layer is a flat surface.

7. The electric field enhancement element according to claim 1, wherein
a diameter of each of the microstructures is larger than an interval between the microstructures adjacent to each other.

8. The electric field enhancement element according to claim 1, wherein
the microstructures are periodically arranged.

9. The electric field enhancement element according to claim 1, wherein
an enhanced electric field generated by the microstructures is maximized at a position that is at an opposite side of the microstructures to the substrate in an extending direction of a perpendicular line of the substrate and is separated from the plurality of microstructures.

10. The electric field enhancement element according to claim 1, wherein
the cover layer is an ALD film.

11. A Raman spectroscopic apparatus comprising:
the electric field enhancement element according to claim 1;
a light source configured to irradiate the electric field enhancement element with light; and
a detector configured to detect Raman scattering light generated from the electric field enhancement element.
